(19) United States
(12) Patent Application Publication
(10) Pub. No.: US 2011/0297014 A1
(43) Pub. Date: Dec. 8, 2011

(54) FLAVOR INJECTOR

(76) Inventor: HEMANT PRAKASHCHANDRA PATEL, ETOBICOKE (CA)

(21) Appl. No.: 12/795,227

(22) Filed: Jun. 7, 2010

(51) Int. Cl. A23B 4/28

(52) U.S. Cl. 99/533

(57) ABSTRACT

A novel device and a novel method to inject solid flavor and liquid flavor into the bodies of meat, bread, cake, sausage, and the like. The device comprises of a hollow tube, a projector rod, and a support rod. One end of the support rod helps in keeping the projector rod steady and stable and the other end of the support rod holds the hollow tube in place and also allows the hollow tube to move back and forth against the projector rod. Once the hollow tube containing the flavor material is injected into the body of meat and the like then the flavor material inside the hollow tube is released into the body of the meat and the like by pulling back the hollow tube against the projector rod and that is the novel idea.

### BACKGROUND OF THE INVENTION

This invention focuses on a novel method of using flavor injector by spreading solid flavor or liquid flavor in a uniform manner throughout the body of the food.

### BRIEF SUMMARY OF THE INVENTION

This invention is a novel device and a novel method of using flavor injector to inject solid flavor and liquid flavor into the bodies of meat, bread, cake, sausage, and the like. This device comprises of a hollow tube, a projector rod, and a support rod. With this novel flavor injector the projector rod is not pushed into the hollow tube but the hollow tube which is filled with solid flavor or liquid flavor which is inserted into the body of meat and the like, is pulled back against the projector rod by which the flavor is released in a uniform manner without creating pouches of flavor and this process happens because of the support rod whose one end supports the projector rod by keeping it steady and stable while the other end of the support rod holds the hollow tube in place and also allows the hollow tube to move back and forth against the projector rod. The front end of the hollow tube is slanted and covered with a flap which remains in a rested position and helps penetrate the bodies of the meat and the like with ease as well as resists any foreign material from entering the hollow tube. The flap opens up when the hollow tube is pulled back against the projector rod in order to release the flavor. Currently available flavor injectors works on the principle of pushing the projector into the hollow tube resulting in creating pouches of flavors within the bodies of the meat and the like where one part of the body of the meat and the like, has all the flavor while the other part of the body of the meat and the like, has no flavor and hence to solve this problem it becomes a necessity to invent this device where the projector rod is kept steady and stable with the help of a support rod and pulling the hollow tube back against the projector rod inorder to release the flavor into the bodies of the meat and the like, in an even and uniform manner. This novel device is relatively inexpensive in terms of manufacturing and is also easy to clean and reassemble for reuse.

### BRIEF DESCRIPTION OF THE SEVERAL VIEWS OF THE DRAWING

FIG. 1 is a right side expanded perspective view.

FIG. 2 is a right side contracted perspective view.

FIG. 3 is a right side exploded perspective view.

### DETAILED DESCRIPTION OF THE INVENTION

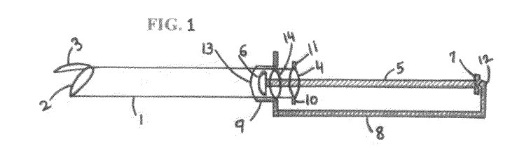

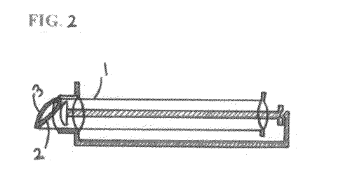

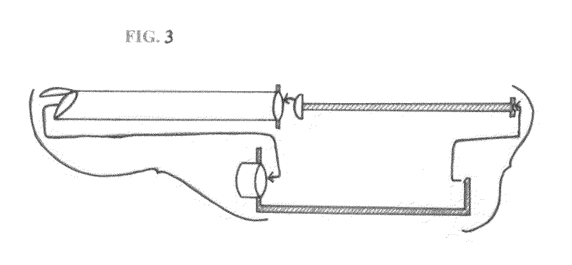

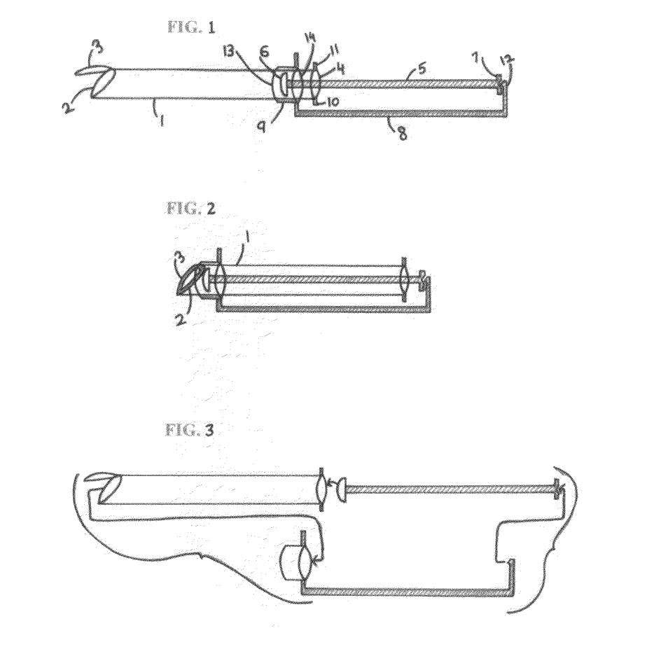

As shown in FIG. 1, the hollow tube (1) has a constant diameted throughout its entire length. The front end (2) of the hollow tube (1) has a slant inorder to penetrate the body of meat and the like. Flap (3) covers the slant of the front end (2) of the hollow tube (1) inorder to avoid any foreign material entering the hollow tube (1) while penetrating the body of the food. Flap (3) is attached to one end of the front end (2) of the hollow tube (1). Flap (3) opens up when the flavor is released from the hollow tube (1), otherwise remains in a rested position over the front end (2) of the hollow tube (1). As shown in FIG. 2, flap (3) is shown in a rested position over the slanted front end (2) of the hollow tube (1). As shown in FIG. 1, the other end (4) of the hollow tube (1) accommodates the projector rod (5) where one end (6) is the head of the projector rod (5) and the other end (7) is the base of the projector rod (5). Both the hollow tube (1) and the projector rod (5) are supported by the support rod (8) where one end (12) of the support rod (8) supports the base (7) of the projector rod (5) and the other end (9) which is in the form of a hollow ring, of the support rod (8) supports the hollow tube (1). Support rod (8) helps to keep the projector rod (5) steady and stable with the help of one end (12) of the support rod (8) and at the same time allows the hollow tube (1) to move back and forth against the projector rod (5) through end (13) and end (14) of the hollow ring (9) of the support rod (8). Handle (10) and handle (11) are attached to the end (4) of the hollow tube (1) in opposite to each other inorder to pull the hollow tube (1) backwards against the projector rod (5) inorder to release solid flavor or liquid flavor in a uniform manner throughout the body of the meat, bread, sausage, cake, and the like. Here FIG. 1 is shown in an expanded form, FIG. 2 is shown in a contracted form, and FIG. 3 is shown in an exploded form.

I claim:

1. A flavor injector device comprising of a hollow tube with a constant diameter throughout its entire length with one end of the hollow tube slanted and covered with a flap inorder to penetrate the bodies of the meat and the like with ease and the flap also resists any foreign body material from entering the hollow tube while the other end of the hollow tube accommodates the projector rod where the projector rod is kept steady and stable by the support made available by one end of the support rod while the other end of the support rod keeps the hollow tube in place and also allows the hollow tube to move back and forth against the steady and stable projector rod and as a result of this process of pulling the hollow tube back against the projector rod, the flavor is released in a uniform manner from the hollow tube into the bodies of meat and the like.
